(19) United States
(12) Patent Application Publication
(10) Pub. No.: US 2003/0012226 A1
(43) Pub. Date: Jan. 16, 2003

(54) Method and apparatus for a blind gain ratio detector

(76) Inventors: Allen He, Fremont, CA (US); Andrew Kevin Prentice, Pleasanton, CA (US); Hongzhi Zhao, San Jose, CA (US)

Correspondence Address: Corporate Patent Counsel, Philips Electronics North America Corporation, 580 White Plains Road, Tarrytown, NY, 10591, US

(21) Appl. No.: 09/904,266

(22) Filed: Jul. 12, 2001

(51) Int. Cl. H04J 13/00; H04B 3/10

(52) U.S. Cl. 370/479; 370/491

(57) ABSTRACT

A method and apparatus for determining the ratio of gain of a first channel to the gain of a second channel, wherein at least one of the first channel and the second channel is constant over time. The ratio is determined by calculating the quotient of the average, or sum, of the gain of the first channel divided by the average, or sum, respectively, of the gain of the second channel.

### TECHNICAL FIELD

The invention relates generally to communications systems and, more particularly, to a method and an apparatus for determining a blind gain ratio.

### BACKGROUND

Wireless communications systems generally involve the transmission of radio frequency (RF) waves from a base antenna to a mobile station, such as a wireless telephone, wireless laptop, a wireless Personal Data Assistant (PDA), and the like. The radio frequency waves are modulated with information bits organized into frames and channels. Some of the channels carry signaling and control information to help manage the communications, and other channels carry user data, such as voice, data, and the like.

The channel information is generally digitized and modulated according to an amplitude and/or a phase-shift keying modulation technique, such as the Quadrature Amplitude Modulator (QAM), Pulse Amplitude Modulation (PAM), Pulse Code Modulation (PCM), Differential Pulse-Code Modulation (DPCM), Phase-Shift Keying (PSK), Differential Phase-Shift Keying (DPSK), Offset Quadrature Phase-Shift Keying (OQPSK), Differential Quadrature Phase-Shift Keying (π/4-QPSK), Gaussian Filtered Minimum Shift Keying (GMSK), and the like. These techniques generally use a constellation, which are known in the art, to equate a digital sequence, known as a symbol, to a pulse signal.

The modulation techniques generally provide a mechanism to restore the signal constellation in the event the signal becomes corrupted due to noise interference and signal fading. In particular, standards such as the 1Xtreme Enhanced Version Data/Voice (1X-EV-DV) standard, based on the 1Xtreme standard for Code Division Multiple Access (CDMA) developed by Motorola, require the relative gain ratio of the Forward Shared Channel (FSHCH) to the Pilot Channel (PCH) be transmitted in the Forward Shared Control Channel (FSHCCH). The relative gain ratio is then used to restore the signal constellation. All channels, including the FSHCCH, however, are susceptible to noise interference and signal fading, thereby possibly inhibiting the restoration of the signal constellation in the event that the FSHCH containing the relative gain ratio becomes corrupted.

Therefore, there is a need for a method and an apparatus for determining the gain ratio of two channels that are less susceptible to noise interference and signal fading. And, in particular, there is a need for a method and an apparatus for determining the gain ratio of the FSHCH to the PCH in standards such as the 1Xtreme CDMA standard.

### SUMMARY

The present invention provides a method and an apparatus for determining the gain ratio of the gain of a first channel to the gain of a second channel. The gain ratio is determined by calculating the quotient of the average and/or sum of samples of the first channel divided by the average and/or sum, respectively, of samples of the second channel.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic diagram of a network environment that embodies features of the present invention;

FIG. 2 is a block diagram illustrating one embodiment of the present invention in which a gain ratio of the FSHCH gain to the PCH gain is determined;

FIG. 3 is a data flow diagram illustrating one embodiment of the present invention in which a gain ratio is determined from a received FSHCH signal and a received PCH signal; and

FIG. 4 is a block diagram illustrating one embodiment of the present invention in which a gain ratio of the FSHCH gain to the PCH gain is determined from the sum of the received FSHCH samples and the sum of the received PCH samples.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning telecommunications and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein may be performed in either hardware or software, or some combination thereof. In a preferred embodiment, however, the functions are implemented in hardware in order to provide the most efficient implementation. Alternatively, the functions may be performed by a processor such as a computer or an electronic data processor in accordance with code such as computer program code, software, and/or integrated circuits that are coded to perform such functions, unless indicated otherwise.

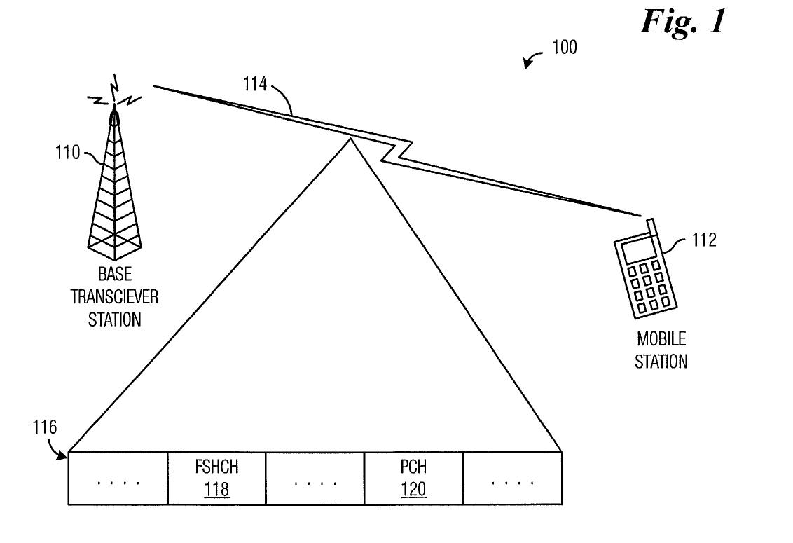

The principles of the present invention and their advantages are best understood by referring to the illustrated embodiment depicted in FIGS. 1-4.

Referring to FIG. 1 of the drawings, the reference numeral 100 generally designates a portion of a communications network which embodies features of the present invention. Specifically, the communications portion 100 comprises a base transceiver station (BTS) 110 configured for communicating to a mobile station (MS) 112, such as a wireless telephone, wireless computer, Personal Data Assistant (PDA), or the like, via an RF interface 114 conforming to one or more wireless communications standards, such as Code Division Multiple Access (CDMA), Time Division Multiple Access (TDMA), Global Systems Mobile (GSM), and the like. This disclosure discusses the invention in terms of CDMA technology, specifically, the 1Xtreme standard, but may be utilized with any technology, wireless or wireline, in which the relative gain of multiple channels is to be determined, and in which the assumptions stated herein are applicable.

Accordingly, the RF interface 114 comprises a reverse-link (i.e., MS-to-BTS communications) (not shown) and a forward-link 116 (i.e., BTS-to-MS communications), each link configured into one or more frames (not shown). Each frame of the forward link 116 comprises, among others, one or more Forward Shared Channel (FSHCH) samples 118 and Pilot Channel (PCH) samples 120. The FSHCH samples 118 generally provide user data, such as voice, data, and the like, and the PCH samples 120 generally provide a synchronization signal for synchronizing the BTS 110 and the MS 112. The channels and the framing of the channels are well known in the art and will not be discussed in greater detail except insofar as is necessary to disclose the present invention.

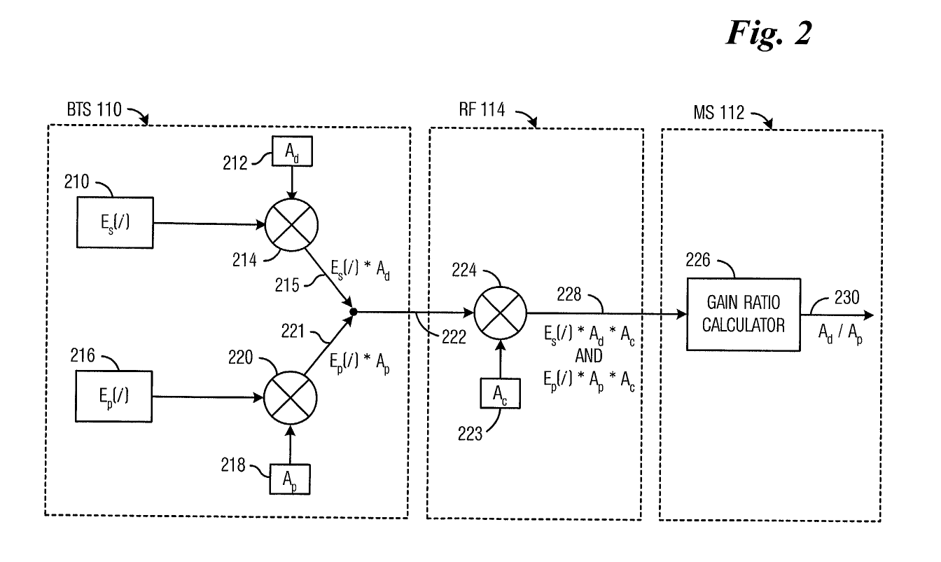

FIG. 2 illustrates one embodiment of the present invention in which the relative gain ratio of the gain of the FSHCH samples 118 to the gain of the PCH samples 120 is determined. The BTS 110, or some other component such as a Base Station Controller (BSC), a Mobile Switching Center (MSC), or the like, converts the values of the FSHCH samples 118 into energy values for the shared channel (Eₛ(i)) 210, where the “i” represents the i^{th} sample. The BTS 110 then applies an FSHCH gain factor (A_{d}) 212 to the Eₛ(i) 210, as indicated by a multiplication function 214, producing a transmitted FSHCH signal 215 equivalent to (A_{d}*Eₛ(i)). The A_{d} is generally constant for all FSHCH samples 118 within a frame of data. The process of converting the FSHCH samples 118 to Eₛ(i) 210, and applying the A_{d} 212 are considered well known in the art and, therefore, will not be discussed in greater detail, except insofar as is necessary to describe the present invention.

Similarly, the BTS 110 converts the PCH samples 120 to energy values Eₚ((i) 216, to which a PCH gain factor (Aₚ) 218 is applied by a multiplication function 220. The result (Aₚ*Eₚ((i)) is the transmitted PCH signal 221. The PCH gain factor Aₚ is generally constant over time, i.e., constant over multiple frames.

The transmitted FSHCH signal 215 and the transmitted PCH signal 221, i.e., (A_{d}*Eₛ(i)) and (Aₚ*Eₚ(i)), respectively, are organized into frames, creating the transmitted signal 222, which is transmitted via the RF interface 114. The process of organizing the data into frames and transmitting the data via the RF interface 114 is well known in the art and, therefore, will not be discussed in greater detail.

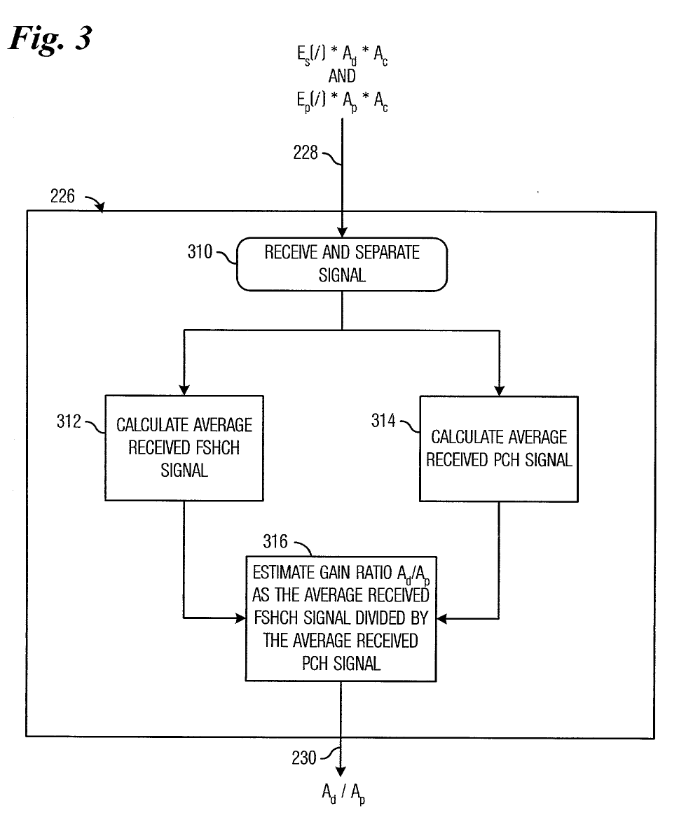

The transmitted signal 222 is generally further affected by channel gain (A_{c}) 223, also known as channel attenuation, as indicated by a multiplication function 224. Generally, the transmitted signal 222 is degraded by such things as path loss, multi-path fading, and the like. Therefore, the received FSHCH signal is represented by the product of the energy of the shared channel, the FSHCH gain, and the channel attenuation, i.e., E_{d}(i)*A_{d}*A_{c}, and the received PCH signal is represented by the product of the energy of the shared channel, the PCH gain, and the channel attenuation, i.e., Eₚ((i)*Aₚ*A_{c}. Upon receipt of the received signal 228, the MS 112 applies a gain rate calculator 226, which is described further below with reference to FIG. 3, the result of which is the approximation of the ratio of the FSHCH gain to the PCH gain, i.e., A_{d}/Aₚ.

FIG. 3 is a data flow diagram of one embodiment that may be used to implement the gain ratio calculator 226 (FIG.2). Specifically, the gain rate calculator 226 receives the received signal 228 and performs steps 310-316, resulting in the gain rate ratio 230 (FIG. 2).

Processing begins in step 310, wherein the received signal 228 is processed. Generally, step 310 processes the received signal 228 by separating the channels and symbols, and converting the channels into the energy of each received symbol. The result of step 310 is the received FSHCH, which is equivalent to the product of the transmitted FSHCH signal Eₛ(i)*A_{d}215 (FIG. 2) and the channel gain A_{c} (FIG. 2), and the received PCH signal, which is equivalent to the product of the transmitted PCH (Eₚ((i)*Aₚ) 221 (FIG. 2) and the channel gain A_{c} (FIG. 2). The process of separating the channels and symbols, and converting the symbols into energy is considered well known to one of ordinary skill in the art and, therefore, will not be discussed in further detail.

After separating the channels and symbols, and converting the symbols to energy, processing continues to steps 312 and 314, which are preferably performed concurrently, wherein the average gain of the received FSHCH signal and average gain of the received PCH signal in a frame are determined. Upon completion of steps 312 and 314, processing continues to step 316, wherein the gain ratio calculator 226 determines the quotient of the average gain of the received FSHCH signals for each frame divided by the average gain of the received PCH signals for each corresponding frame. The quotient, represented by AVG(Eₛ(i)* A_{d}*A_{c})/AVG(Eₚ((i)*Aₚ*A_{c}), is approximately equivalent to the ratio of the gain of the FSHCH channel to the gain of the PCH channel, A_{d}/Aₚ.

The approximation can be derived by evaluating the received FSHCH signals and the received PCH signals. First, assumptions are made that the FSHCH samples are distributed uniformly over the constellation over time, that the channel attenuation is the same for both the PCH and the FSHCH, and that the channel attenuation is independent of the FSHCH. Given these assumptions, the following average gain of the FSHCH may be stated as:

avg(A_{c}*A_{d}*Eₛ(i))=avg(A_{c})*avg(A_{d})*avg(Eₛ(i)) (Eq. 1)

Since it is assumed that the channel gain of the FSHCH channel is constant over a frame, Eq. 1 becomes:

avg(A_{c}*A_{d}*Eₛ(i))=avg(A_{c})*A_{d}*avg(Eₛ(i)) (Eq. 2)

Furthermore, since the Eₛ(i) is assumed to be uniformly distributed over the constellation, the avg(Eₛ(i)) is approximately equal to 1, allowing the avg(Eₛ(i)) to be dropped from Eq. 2, leaving the following equation:

avg(A_{c}*A_{d}*Eₛ(i))=avg(A_{c})*A_{d} (Eq. 3)

Following similar logic for the PCH signal provides the following derivation:

avg(A_{c}*Aₚ*Eₚ((i))=avg(A_{c})*avg(Aₚ)*avg(Eₚ((i))

avg(A_{c}*Aₚ*Eₚ((i))=avg(A_{c})*Aₚ*avg(Eₚ((i))

avg(A_{c}*Aₚ*Eₚ((i))=avg(A_{c})*Aₚ (Eq. 4)

The ratio of the FSHCH to the PCH can therefore be expressed as:

$$\frac{avg ( {A}_{c} * {A}_{d} * {E}_{s} ( i ) )}{avg ( {A}_{c} * {A}_{p} * {E}_{p} ( i ) )} = \frac{avg ( {A}_{c} ) * {A}_{d}}{avg ( {A}_{c} ) * {A}_{p}} \qquad ( Eq . 5 )$$

Therefore, after eliminating the avg(A_{c}) from the numerator and denominator, Eq. 5 becomes:

$$\frac{avg ( {A}_{c} * {A}_{d} * {E}_{s} ( i ) )}{avg ( {A}_{c} * {A}_{p} * {E}_{p} ( i ) )} = \frac{{A}_{d}}{{A}_{p}}$$

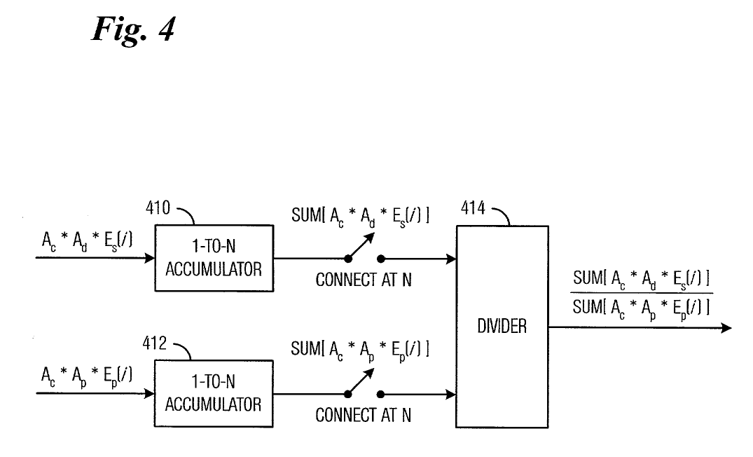

FIG. 4 represents one embodiment for implementing the process described in FIG. 3 in a hardware implementation, wherein accumulators and a divider are used to calculate the ratio of the gain of the FSHCH to the gain of the PCH. Preferably utilizing concurrent processing, an accumulator 410 receives as input the Eₛ(i)*A_{d}*A_{c} and an accumulator 412 receives as input the Eₚ((i)*Aₚ*A_{c}. The accumulators 410 and 412 calculate the sum of the Eₛ(i)*A_{d}*A_{c} and the sum of the Eₚ((i)*Aₚ*A_{c}, respectively, over each frame. The output of the of the accumulators 410 and 412 are input to a divider 414. The divider 414 determines the quotient of the Eₛ(i)*A_{d}*A_{c} divided by the Eₚ((i)*Aₚ*A_{c}. Since a frame contains the same number of samples of the FSHCH and PCH per frame, a sum function may be used in place of the average function of Eq. 6 as follows:

$$\frac{avg ( {A}_{c} * {A}_{d} * {E}_{s} ( i ) )}{avg ( {A}_{c} * {A}_{p} * {E}_{p} ( i ) )} = \frac{\sum ( {A}_{c} * {A}_{d} * {E}_{s} ( i ) )}{\sum ( {A}_{c} * {A}_{p} * {E}_{p} ( i ) )} \qquad ( Eq . 7 )$$

The use of the SUM function is preferred over the average function because the sum function may be calculated more efficiently than the average function.

Alternatively, a sliding window method may be utilized. The sliding window method, well known in the art, is a method in which the division function, which is generally a time consuming function, is performed on partial data. A determination is then made upon the receipt of the additional samples whether the result of the division function would change significantly. If a determination is made that the result would not change significantly, then the result based on partial data is used. If, however, a determination is made that the result would change significantly, then a second division is performed on the complete and/or additional data.

It is understood that the present invention can take many forms and embodiments. Accordingly, several variations may be made in the foregoing without departing from the spirit or the scope of the invention. For example, the present invention may be embodied in any device, such as a wireless/wireline telephone, computer, PDA, or the like, in a component configured to connect to a device, in a component configured as an element of a device, or the like.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. An apparatus comprising:
means for calculating a first gain value representing the gain of one or more first channel samples of a first channel of a signal;
means for calculating a second gain value representing the gain of one or more second channel samples of a second channel of the signal; and
means for calculating a gain ratio of the first gain value to the second gain value as the quotient of the first gain value divided by the second gain value.

2. The apparatus of claim 1, wherein the means for calculating the first gain value comprises at least one of an average gain of the one or more first channel samples and a summation of the one or more first channel samples.

3. The apparatus of claim 1, wherein the means for calculating the second gain value comprises at least one of an average gain of the one or more second channel samples and a summation of the one or more second channel samples.

4. The apparatus of claim 1, wherein the first channel is the Forward Shared Channel and the signal is a Code Division Multiple Access signal.

5. The apparatus of claim 1, wherein the second channel is the Pilot Channel and the signal is a Code Division Multiple Access signal.

6. An apparatus comprising:
first accumulator means for calculating a first sum equal to the summing of one or more first samples, the first samples representing the received energy of a first channel within a frame of a signal;
second accumulator means for calculating a second sum equal to the summing of one or more second samples, the second samples representing the received energy of a second channel within the frame of the signal; and
a divider means coupled to the first accumulator means and the second accumulator means for calculating the quotient of the first sum divided by the second sum.

7. The apparatus of claim 6, wherein the first channel is the Forward Shared Channel and the signal is a Code Division Multiple Access signal.

8. The apparatus of claim 6, wherein the second channel is the Pilot Channel and the signal is a Code Division Multiple Access signal.

9. An apparatus comprising:
means for calculating a Forward Shared Channel (FSHCH) gain representing the gain of one or more received FSHCH samples;
means for calculating a Pilot Channel (PCH) gain representing the gain of one or more received PCH samples; and
means for estimating a gain ratio of the FSHCH to the PCH as the quotient of the FSHCH gain divided by the PCH gain.

10. A method comprising the steps of:
calculating a first gain value representing the gain of one or more first channel samples of a first channel of a signal;
calculating a second gain value representing the gain of one or more second channel samples of a second channel of the signal; and
calculating a gain ratio of the first gain value to the second gain value as the quotient of the first gain value divided by the second gain value.

11. The method of claim 10, wherein the step of calculating the first gain value comprises at least one of calculating an average gain of the one or more first channel samples and calculating a summation of the one or more first channel samples.

12. The method of claim 10, wherein the step of calculating the second gain value comprises at least one of calculating an average gain of the one or more second channel samples and calculating a summation of the one or more second channel samples.

13. The method of claim 10, wherein the first channel is the Forward Shared Channel and the signal is a Code Division Multiple Access signal.

14. The method of claim 10, wherein the second channel is the Pilot Channel and the signal is a Code Division Multiple Access signal.

15. A method comprising the steps of:
calculating a Forward Shared Channel (FSHCH) gain representing the gain of one or more received FSHCH samples;
calculating a Pilot Channel (PCH) gain representing the gain of one or more received PCH samples; and
calculating a gain ratio of the FSHCH to the PCH as the quotient of the FSHCH gain divided by the PCH gain.
